(19) United States
(12) Patent Application Publication
(10) Pub. No.: US 2007/0068346 A1
(43) Pub. Date: Mar. 29, 2007

(54) Pneumatic ratchet drive tool

(75) Inventor: Tomokazu Izumisawa, Tokyo (JP)

Correspondence Address: SENNIGER POWERS, ONE METROPOLITAN SQUARE, 16TH FLOOR, ST LOUIS, MO, 63102, US

(73) Assignee: SP Air Kabushiki Kaisha, Tokyo (JP)

(21) Appl. No.: 11/234,042

(22) Filed: Sep. 23, 2005

(51) Int. Cl. B25B 17/00; B25B 13/46

(52) U.S. Cl. 81/57.39

(57) ABSTRACT

A pneumatic ratchet drive tool includes an elongate housing having opposite first and second ends and a longitudinal axis. An air inlet is disposed at the first end, and a head extends generally axially from the second end. The tool includes a ratchet mechanism, and a bit receiver extending from the head and being operatively connected to ratchet mechanism. The bit receiver defines a bit socket for receiving and temporarily retaining a bit. The socket has a longitudinal axis generally orthogonal to the axes of the housing and the head.

### BACKGROUND OF THE INVENTION

The present invention relates generally to a pneumatic ratchet drive tool, and more particularly, to a pneumatic ratchet drive tool including a bit receiver defining a bit socket for receiving and temporarily retaining a bit.

Conventional pneumatic ratchet drive wrenches are typically used to fasten (and unfasten) fasteners that do not have cavities formed in their heads, but are instead adapted to be received in a socket of a tool, such as a ratchet. Such fasteners include, for example, hexagonal bolts and hexagonal nuts for being received in a hexagonal socket. The wrench typically includes a housing, a head extending axially from the housing, and a male socket fitting extending generally orthogonally from the head for mating with a socket or other tool. The male socket fitting is generally a square-shaped nub that is adapted to be received in an opening of the socket. Because the housing and the head are axially aligned and the male socket fitting extends generally orthogonally from the head of the ratchet, the ratchet can be employed in tight places where movement of the ratchet is restricted, such as in automotive repair and industrial applications.

Other types of fasteners have cavities formed in their heads for receiving a bit or head of a tool to fasten the fastener. Such fasteners include, for example, Phillips-head fasteners, slotted-head fasteners, and Torx® fasteners. Using a ratchet device to fasten these types of fasteners would be advantageous because of the compact design of the ratchet. However, conventional ratchets have only the male socket fittings for mating with sockets that receive heads of fasteners.

### SUMMARY OF THE INVENTION

In one aspect of the present invention, a pneumatic ratchet drive tool generally comprises an elongate housing having first and second opposite ends and a longitudinal axis extending therebetween. An air inlet is disposed at the first end of the housing for connection to a source of pressurized air. A head extends generally axially from the second end of the housing. The drive tool comprises a ratchet mechanism, and a bit receiver extends from the head and is operatively connected to the ratchet mechanism. The bit receiver defines a bit socket for receiving and temporarily retaining a bit. The socket has a longitudinal axis generally orthogonal to the axes of the housing and the head.

Other objects and features will be in part apparent and in part pointed out hereinafter.

### BRIEF DESCRIPTION OF THE DRAWINGS

FIG. 1 is a perspective of one embodiment of a pneumatic ratchet drive tool the present invention;

FIG. 2 is an exploded perspective of internal components of a head of the ratchet drive tool;

FIG. 3 is a right side, fragmentary section of a head of the ratchet tool;

FIG. 4 is an enlarged perspective of a bit receiver and an associated rotary wheel with a bit retainer exploded from the bit receiver;

FIG. 5 is a front elevation of the bit receiver and associated rotary wheel; and

FIG. 6 is a fragmentary perspective of the drive tool showing a bit exploded from the bit receiver.

Corresponding reference characters indicate corresponding parts throughout the drawings.

### DETAILED DESCRIPTION

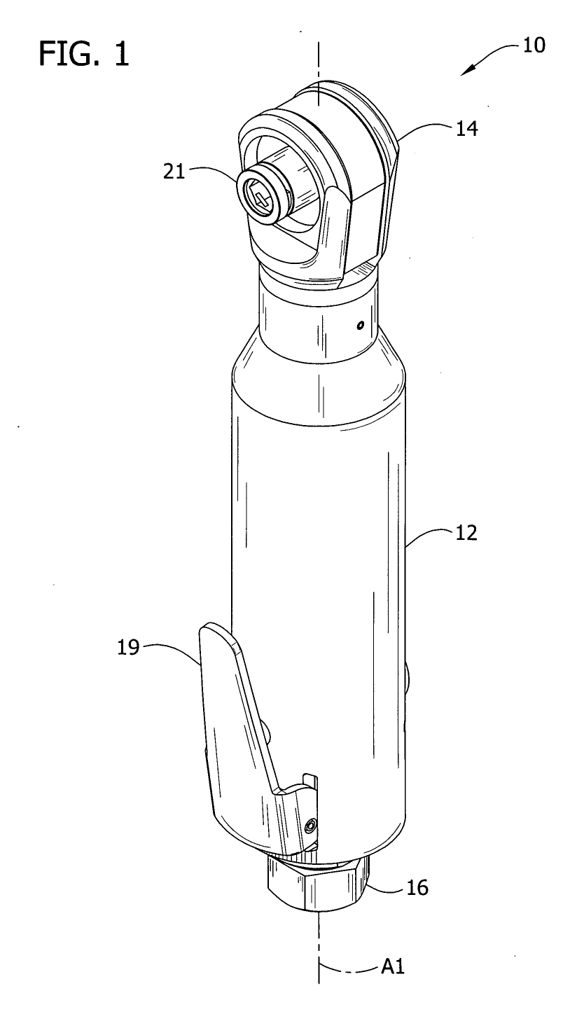

Referring now to the drawings and particularly to FIG. 1, a pneumatic drive ratchet tool constructed according to the teachings of the present invention is generally indicated at reference numeral 10. The ratchet tool 10 includes an elongate housing 12 having a longitudinal axis A1. A head 14 of the tool 10 extends axially from one end of the housing 12, and an air inlet 16 extends from an opposite end for connection to a source of pressurized air (not shown). A trigger 19 for controlling the introduction of pressurized air into the housing 12 is adjacent the air inlet 16. A bit receiver 21 for receiving a suitable bit projects laterally from the head 14. The components of the ratchet 10 are constructed of metal, and more specifically steel, although it is contemplated that the components may be constructed of other materials, such as plastic.

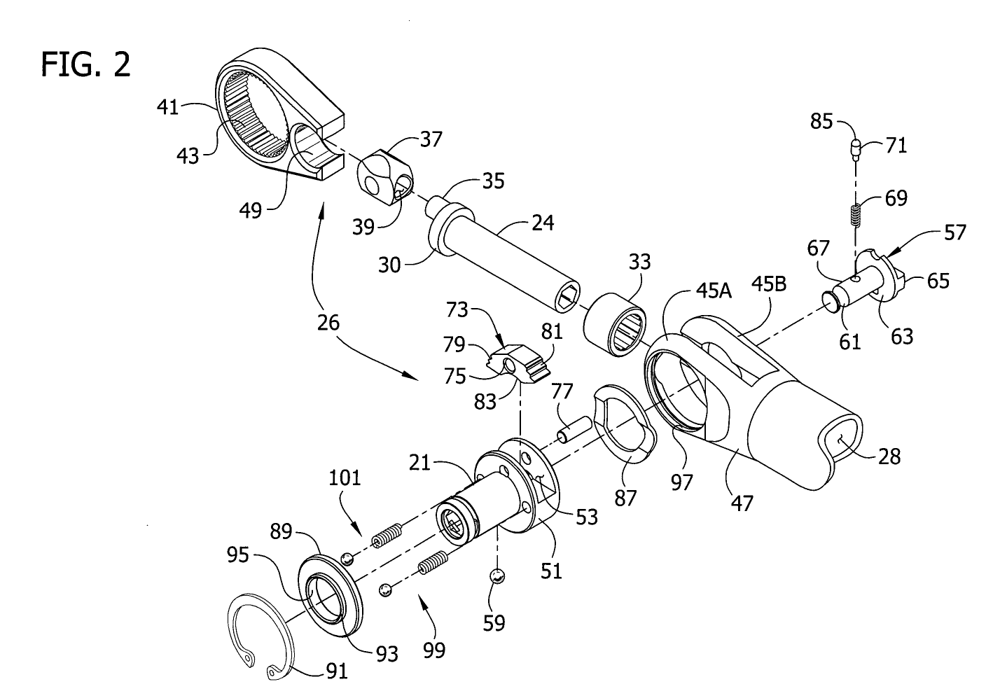

Referring to FIG. 2, in one example, the ratchet tool 10 includes a crank shaft 24 that operatively connects an impact drive output shaft (not shown) to a ratchet mechanism 26 for converting rotary motion of the output shaft into oscillating motion of the ratchet mechanism. The output shaft is connected to an air motor (not shown) for rotating the shaft. The crank shaft 24 is located within a bore 28 of the head 5. A flange 30 of the crank shaft 24 rests on top of a needle bearing 33 fitted within the bore 28, supporting the crank shaft 24 for axial rotation within the head 5 conjointly with the output shaft 47. A crank 35 extends from the flange 30 and is off-center from the center of the shaft 24. A drive bearing 37 having generally spherical shaped sides and opening 39 rotatably receives the crankshaft's crank 35. An oscillating member 41 of the ratchet mechanism 26 is located between arms 45A and 45B of a yoke 47 of the head 5. A toothed opening 43 in the oscillating member 41 generally aligns with openings in the arms 45A, 45B of the yoke 47 for receiving components of the ratchet mechanism 26, as will be described hereinafter. The drive bearing 37 slidably fits in a semicircular opening 49 of the oscillating member 41. As the crank 35 rotates, the drive bearing 37 moves in a circular motion within the oscillating member's semicircular opening 49, causing the member 41 to rock back and forth about a longitudinal axis of the bit receiver 21.

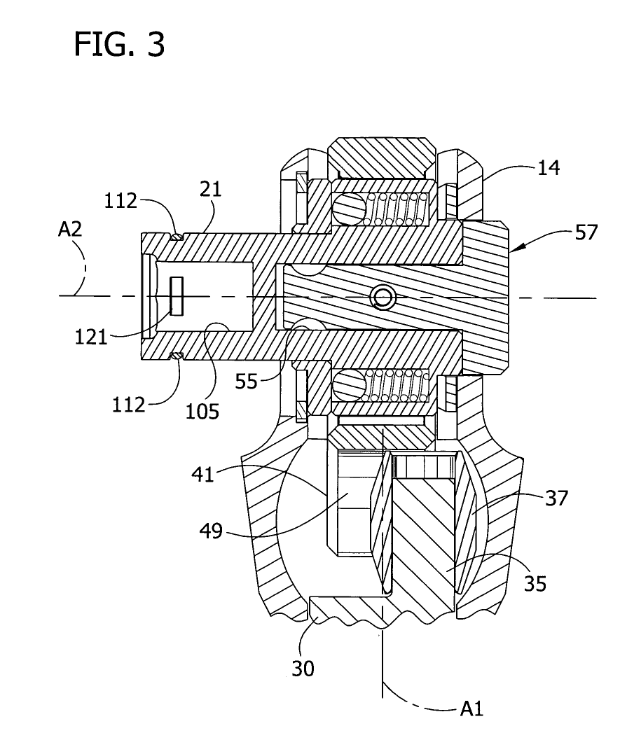

The ratchet mechanism 26 generally includes a rotary wheel 51 sized to fit in the aligning openings of the yoke arms 45A, 45B and oscillating member 41. The rotary wheel 51 has a generally circumferential slot 53 in it extending through about half of the circumference of the rotary wheel. The bit receiver 21 extends laterally outward from the rotary wheel 51. Opposite the bit receiver 21 in the rotary wheel 51 is an axial bore 55 (FIG. 3), which intersects the bottom of the circumferential slot 53. A setting member 57 for setting rotational direction of the bit receiver 21 (e.g., clockwise or counterclockwise) is received within the axial bore 55 (secured by ball bearing 59 in groove 61) and includes a disc 63 having a fingerpiece 65 extending from one side to allow it to be manually rotated. The setting member 57 has an extending shaft 67 with a transverse bore therein receiving a spring 69 for biasing a plunger 71.

The ratchet mechanism 26 also includes a ratchet pawl, designated generally at 73, for controlling rotational direction of the bit receiver 21. The pawl 73 has a transverse bore 75 through it so that it can be mounted in the circumferential slot 53 in the rotary wheel 51 by way of inserting a pin 77 through the sides of the pawl and the sides of the rotary wheel. The pawl 73 has slanted or generally arcuate end parts as designated at 79 and 81. These portions have teeth that are configured to engage with the teeth on the inside of the opening 43 of the oscillating member 41. The pawl 73 has a groove or channel 83 formed in one longitudinal side for pivoting on the pin 77 when pushed by a free end 85 of the plunger, which is held against the pawl by the spring 69. Thus, it may be seen that by manually rotating the setting member 57 by means of the fingerpiece 65, the setting member shaft can be rotated angularly, which rotates the plunger 71 within the channel 83 of the pawl 73. In a first position, the pawl 73 is positioned to be rotated by the oscillating member 41 angularly in one direction (e.g., clockwise). In a second position, the pawl 73 is positioned to be rotated by the oscillating member 41 angularly in the opposite direction (e.g., counterclockwise). Each end of the ratchet pawl 73 operates only in one direction, and is free to move in a direction opposite to that direction.

The rotary wheel 51 is held in the yoke 47 of the head 5 on one side by a thrust washer 87, which is generally resilient and made of a spring material. The thrust washer 87 has waves, or bends in it in a circumferential direction so that it can be pressed between the rotary wheel 51 and yoke 47, holding them together. On the other side of the head 5, the rotary wheel 51 is held in place within the yoke 47 by a plate 89 and snap ring 91. The plate 89 has an extending circular boss 93, holding the snap ring 91, and a center bore 95 fitting over the bit receiver 21. The plate 89 fits into the opening of one arm 45B of the yoke 47 and is held in place by the snap ring 91 fit into an undercut 97 in the yoke arm opening. Spring loaded ball bearings (each designated generally by 99 and 101) apply force to hold the plate 89, thrust washer 87, and rotary wheel 51 in place. An example of similar pneumatic ratchets employing this type of ratchet mechanism is taught by co-owned U.S. patent application Ser. No. 10/938,312, the entirety of which is herein incorporated by reference.

In operation, the output shaft 47 rotates the crank shaft 24 and drive bearing 37, causing the oscillating member 41 to pivot about the longitudinal axis of the bit receiver 21. When oriented for turning the bit receiver 21 in a clockwise direction, the pawl is pivoted on plunger 71 so that pawl end part 81 engages the opening 43 of the oscillating member 41. The oscillating member 41 first moves clockwise when the crank shaft 24 and drive bearing 37 rotate. The teeth of the opening 43 of the oscillating member 41 engage the teeth of the pawl end part 81 and cause the rotary wheel 51 to rotate clockwise with the oscillating member. This also rotates the bit receiver 21 clockwise. After the crank shaft 24 rotates one half rotation (i.e., rotates 180°), the drive 37 causes the oscillating member 41 to reverse rotation and rotate counterclockwise. The teeth of the oscillating member's opening 43 disengage the teeth of the pawl end part 81 and slide past each other. Here, the rotary wheel 51 does not move. Once the crank shaft 24 rotates another one half rotation, the drive bearing 37 again causes the oscillating member 41 to reverse rotation back in a counterclockwise direction. This causes the teeth of the oscillating member's opening 81 to re-engage the teeth of the pawl end part 81 and rotate the rotary wheel 51, further turning the bit receiver 21 again. The process repeats until the motor is disengaged. Operation is similar for turning the bit receiver 21 in a counterclockwise direction, with the exception that the pawl end part 79 (instead of end part 81) engages the teeth of the oscillating member's opening 43 so that the bit receiver can be turned in the opposite direction (i.e., counterclockwise).

It is understood that the construction of the ratchet tool, more particularly the construction of the ratchet mechanism, for producing rotational movement of the bit retainer may differ from the illustrated embodiment without departing from the scope of this invention. For example, the ratchet mechanism may be similar to the mechanism disclosed in U.S. Pat. Nos. 6,578,643 and 6,860,174, both of which are herein incorporated by reference. Rotary wheel (i.e., ratchet wheel) of this specific type of ratchet mechanism includes teeth extending outward from the member around its full circumference that are engaged by a pair of pawls pivotally mounted on an oscillating member (i.e., rocker). Other types of ratchet mechanisms are within the scope of this invention.

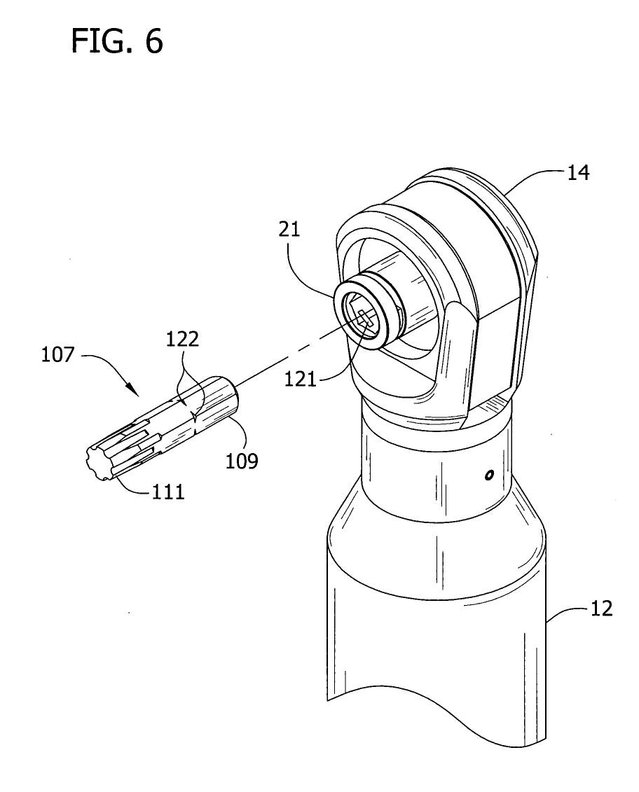

Referring now to FIGS. 3-6, a hexagonal bit socket 105 is formed in the bit receiver 21 for receiving and temporarily retaining a bit, indicated generally at 107 in FIG. 6, having a body 109 of a corresponding shape (e.g., hexagonal) and size. It is understood that shape and size of the socket 105 may vary without departing from the scope of this invention. The bit socket 105 has a longitudinal axis A2 (FIG. 3) that is generally orthogonal to the axes of the housing A1, the head and the axis of rotation of the output shaft 37. The illustrated bit 107 of FIG. 6 has a star-shaped head 111 for use in fastening and unfastening Torx® fasteners, but it is understood that the present invention is suitable for use with bits having different heads shaped and sized for different fasteners, including but not limited to Phillips-head fasteners and slotted-head fasteners.

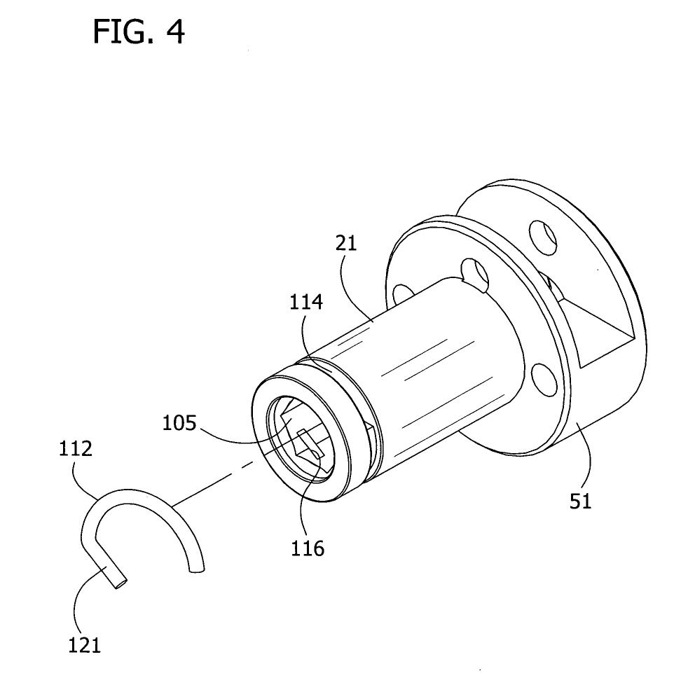

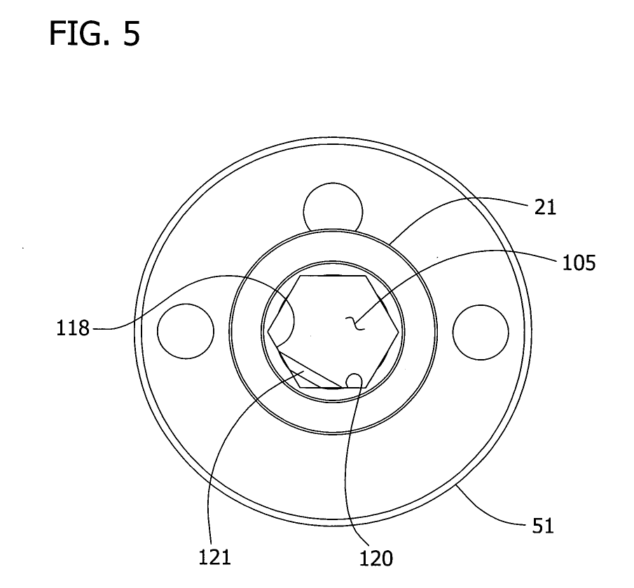

The ratchet tool 10 includes a bit retainer 112 for temporarily retaining a bit 107 in the socket 105. In the illustrated embodiment, the bit retainer 112 is generally C-shaped and received within a channel-shaped recess 114 formed around the periphery of the bit receiver 21, as shown best in FIG. 4. A slot 116 (FIG. 4) in the bit receiver 21 runs transversely through a corner of two adjacent sides 118, 120 of the socket 105. As shown in FIG. 5, when the bit retainer 112 is in an engagement position, a straight engagement portion 121 of the bit retainer projects through the slot 116 into the socket 105. When the bit retainer 112 is in a retracted position, the engagement portion 121 does not extend into the socket 105. The bit retainer 112 is biased by its own resilience toward the engagement position and is at least partially resiliently deformable to allow the engagement portion 121 to return to its engagement position from its retracted position. For reasons discussed below, the bit 107 for use with this embodiment has slots 122 formed on the exterior surface extending transversely through corners of the bit (FIG. 6). Preferably, each corner (e.g., each of the six corners of the illustrated embodiment) of the bit 107 has a slot formed therethrough.

In use, as the bit 107 is inserted to the socket 105, a tapered end of a bit contacts the engagement portion 121 of the bit retainer 112 and forces the engagement portion 121 substantially out of the socket and into its retracted position. As the bit 107 continues into the socket 105, a respective corner of the bit continues to contact the engagement portion 121 of the bit retainer 112. When the bit 107, and more specifically the body 109 of the bit, is fully received in the socket 105, the engagement portion 121 moves into its engagement position and the projecting portion is received in the slot 122 of the corresponding corner of the bit, such that the edges of the slot catch on the engagement portion to retain the bit in the socket. To remove the bit 107, the bit is pulled from the socket 105. As the bit 107 is pulled, the corner of the bit once again contacts the engagement portion 121 of the bit retainer 112, moving the bit retainer into its retracted position. Other ways of retaining the bit in the socket are within the scope of this invention.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions without departing from the scope of the invention, it is intended that all matter contained in the above description and shown in the accompanying drawings shall be interpreted as illustrative and not in a limiting sense.

What is claimed is:

1. A pneumatic ratchet drive tool comprising:
an elongate housing having first and second opposite ends and a longitudinal axis extending therebetween,
an air inlet disposed at the first end of the housing for connection to a source of pressurized air;
a head extending generally axially from the second end of the housing,
a ratchet mechanism, and
a bit receiver extending from the head and operatively connected to the ratchet mechanism, the bit receiver defining a bit socket for receiving and temporarily retaining a bit, said socket having a longitudinal axis generally orthogonal to the axes of the housing and the head.

2. The tool as set forth in claim 1 wherein the bit receiver is attached directly to the ratchet mechanism.

3. The tool as set forth in claim 2 wherein the ratchet mechanism comprises a rotary wheel, and wherein the bit receiver is attached to the rotary wheel for rotationally driving the bit receiver, and wherein the ratchet mechanism further comprises at least one pawl inside the housing for driving the ratchet wheel.

4. The tool as set forth in claim 1 further comprising a bit retainer for temporarily retaining a received bit in the socket.

5. The tool as set forth in claim 4 wherein said bit retainer is movable between an engagement position, in which it projects into the socket to retain the bit in the socket and a retracted position in which it is substantially retracted from the socket to release the bit from the socket.

6. The tool as set forth in claim 4 wherein said bit retainer is elastically deformable and biased toward the engagement position.

7. The tool as set forth in claim 1 in combination with a bit for being received in the bit socket, said bit having at least one slot disposed on the exterior surface for receiving the bit retainer when the bit retainer is in the engagement position, thereby temporarily retaining the bit in the socket.

8. The tool as set forth in claim 7 wherein the socket and the bit each have a hexagonal cross-section.
